(19) United States
(12) Patent Application Publication
(10) Pub. No.: US 2007/0217625 A1
(43) Pub. Date: Sep. 20, 2007

(54) Loudspeaker system having sensorless bass compensation

(75) Inventors: Ming-Shian Bai, Hsinchu City (TW); Chih-Chung Lee, Dali City (TW); Chien-Liang Lin, Tainan City (TW)

Correspondence Address: TROXELL LAW OFFICE PLLC, SUITE 1404, 5205 LEESBURG PIKE, FALLS CHURCH, VA, 22041, US

(73) Assignee: National Chiao Tung University

(21) Appl. No.: 11/367,370

(22) Filed: Mar. 6, 2006

(51) Int. Cl. H04R 3/00; H04R 29/00

(52) U.S. Cl. 381/96; 381/59

(57) ABSTRACT

The present invention compensates bass frequency for a loudspeaker without using any sensor. The strength and stability of the loudspeaker are enhanced and the working frequency is lowered too. Adaptive loudnesses for various spaces are set. And the parameter drift owing to long-term operation is restrained as well.

### FIELD OF THE INVENTION

The present invention relates to a loudspeaker; more particularly, relates to containing a double-layer hybrid control architecture and a volume velocity estimation observer using no sensor, where a working frequency of the loudspeaker is lowered and a loudness for a space is equalized.

### DESCRIPTION OF THE RELATED ARTS

In the U.S. Pat. No. 5,305,388, “Bass compensation circuit for use in sound reproduction device”, a device like an equalizer is used. Low frequency is compensated by using a filter with high Q-value. But, a physical limitation to the device still exists where an over-compensation may make the device operate in a non-linear area.

In 1991, D. K. Anthony and S. J. Elliott, etc. reported “A comparison of three methods of measuring the volume velocity of an acoustic source”, where all the three methods had to use sensors for measuring.

A method for bass enhancement is proclaimed in the U.S. Pat. No. 5,930,373, “Method and system for enhancing quality of sound signal”. It has a method for conveying to a listener a pseudo low frequency psycho-acoustic sensation of a sound signal, comprising steps of: (i) deriving from a sound signal, a high frequency signal and a low frequency signal (LF signal) which extends over a low frequency range of interest; (ii) for each fundamental frequency within the low frequency range of interest, generating a residue harmonic signal having a sequence of harmonics, where the sequence of harmonics, generated with respect to each fundamental frequency, contains a group of harmonics that includes at least three consecutive harmonics from among a set of harmonics of the fundamental frequency; and (iii) bringing the loudness of the residue harmonic signal to essentially match the loudness of the low frequency signal so that the residue harmonic signal and the high frequency signal is summed to obtain psychoacoustic alternative signal. Therein, a pseudo bass frequency is obtained by adding some harmonics according to psychoacoustics. Yet the original sound is changed by adding those extra signals and the bass sound is a pseudo bass sound not a real one.

The above prior arts enhance bass sound and uses sensors to measure volume velocity. Regarding enhancing bass sound, high Q-value may be added to compensate bass sound to an extension into a non-linear area; or extra signals may be added to obtain a pseudo bass sound by changing the original sound. Regarding measuring volume velocity, sensor is always required. Hence, the prior arts do not fulfill users' requests on actual use.

### SUMMARY OF THE INVENTION

The main purpose of the present invention is to lower a working frequency of a loudspeaker, to obtain adaptive loudnesses of low frequency for various spaces, and to restrain parameter drift owing to a long-term operation.

To achieve the above purpose, the present invention is a loudspeaker system having a sensorless bass compensation, comprising a double-layer hybrid control architecture with a feed-forward control device and a feedback control device, and a volume velocity estimation observer, where the volume velocity estimation observer estimates a volume velocity through a dynamic equation and a linear quadratic Guass theorem without using any sensor; the feed-forward control device is deposed on a digital signal processor and comprises at least one filtering device; and the feedback control device is deposed on an analog circuit and is designed according to a quantitative feedback technique. Accordingly, a novel loudspeaker system having a sensorless bass compensation is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing a structure of a preferred embodiment according to the present invention;

FIG. 2 is a view showing volume velocity curves obtained by using the volume velocity estimation observer and a laser displacement meter; and

FIG. 3 is a view showing sound pressure curves.

### DESCRIPTION OF THE PREFERRED EMBODIMENT

The following description of the preferred embodiment is provided to understand the features and the structures of the present invention.

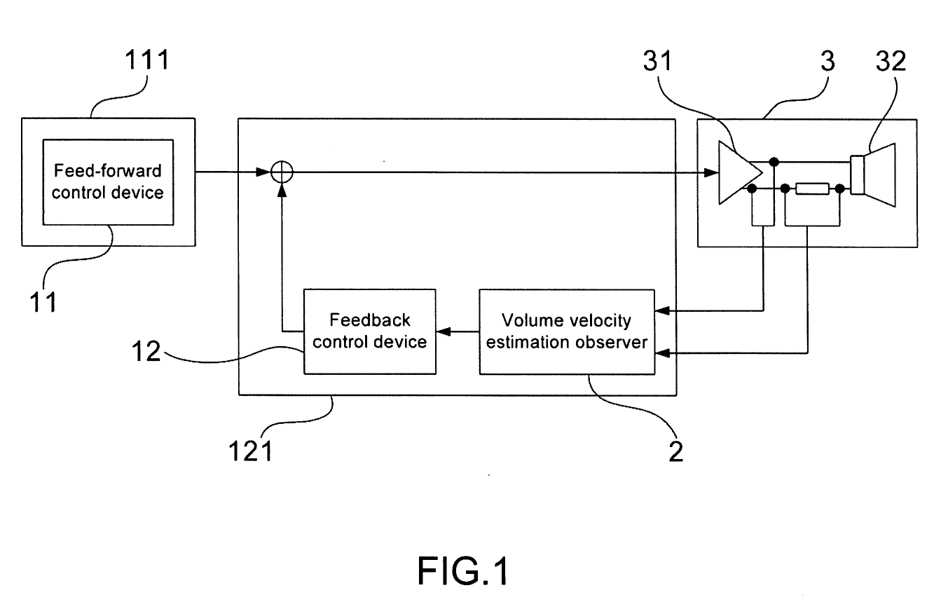

Please refer to FIG. 1, which is a view showing a structure of a preferred embodiment according to the present invention. As shown in the figure, the present invention is a loudspeaker system having a sensorless bass compensation, comprising a double-layer hybrid control architecture with a feed-forward control device 11 and a feedback control device 12; and a volume velocity estimation observer 2. Therein, the double-layer hybrid control architecture improves a loudness of a loudspeaker device 3, especially in the bass frequency area. The feed-forward control device 11 is used to improve a bass efficiency and to equalize a loudness for a space, where the feed-forward control device 11 has various compensating-and-filtering devices and is deposed on a digital signal processor (DSP) 111. The feed back control device 12 is deposed on an analog circuit 121 with fast response and lessened general delay and is a feedback compensation device to restrain disturbances. Yet the order of the feedback control device 12 is limited, where the feedback is obtained through a design according to a quantitative feedback technique. The volume velocity estimation observer 2 estimates volume velocity according to a dynamic equation and a linear quadratic Guass theorem without using any sensor; and the volume velocity estimation observer 2 is connected with the feedback control device 12 to improve stability when the loudspeaker device 3 functions and/or the loudness for the space changes.

The present invention is further connected with the loudspeaker device 3, comprising an amplifier 31 and a moving coil loudspeaker 32. Regarding an operation of the present invention, a sound signal is transferred from the feed-forward control device 11 on the DSP 111; the loudspeaker device 3 transfers an open circuit voltage and a coil current to the volume velocity estimation observer 2 to obtain a coil frequency through a computation to be sent back to the feedback control device 12. Then the feedback control device 12 sends a signal for compensating and filtering the inputted signal from the feed-forward control device 11; and, then, the inputted signal is transferred to the loudspeaker device 3. Hence, the present invention is capable of adaptive modeling and of being a synthesis filter, where adaptive loudnesses of low frequency for various spaces are obtained and parameter drift owing to long-term operation is restrained.

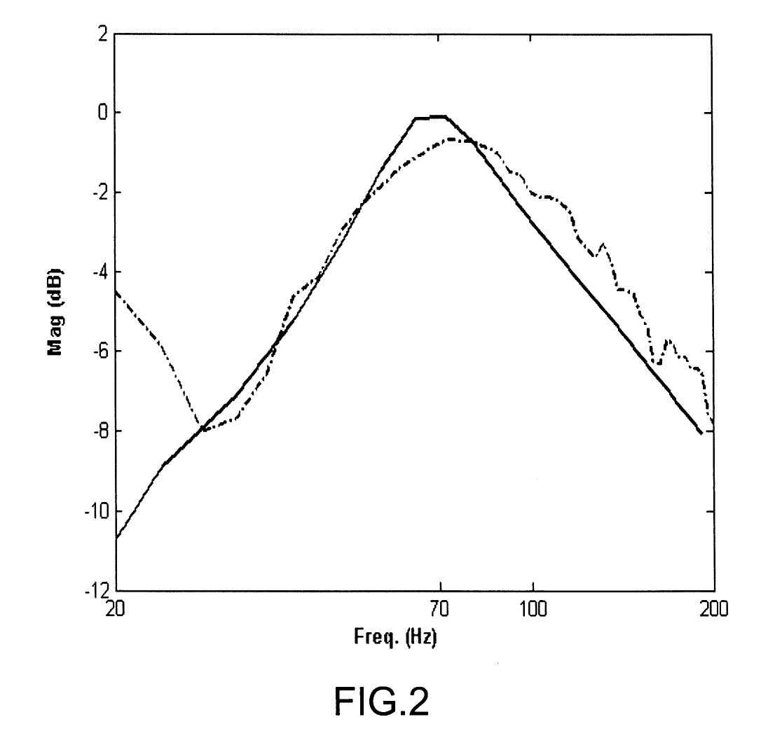

Please refer to FIG. 2, which is a view showing volume velocity curves obtained by using the volume velocity estimation observer and a laser displacement meter. As shown in the figure, vibration frequencies are measured by using the volume velocity estimation observer and a laser displacement meter, including a first curve 41 obtained by using the volume velocity estimation observer and a second curve 42 obtained by using the laser displacement meter. The first curve 41 and the second curve 42 are almost coincided, which proves the present invention is a good design.

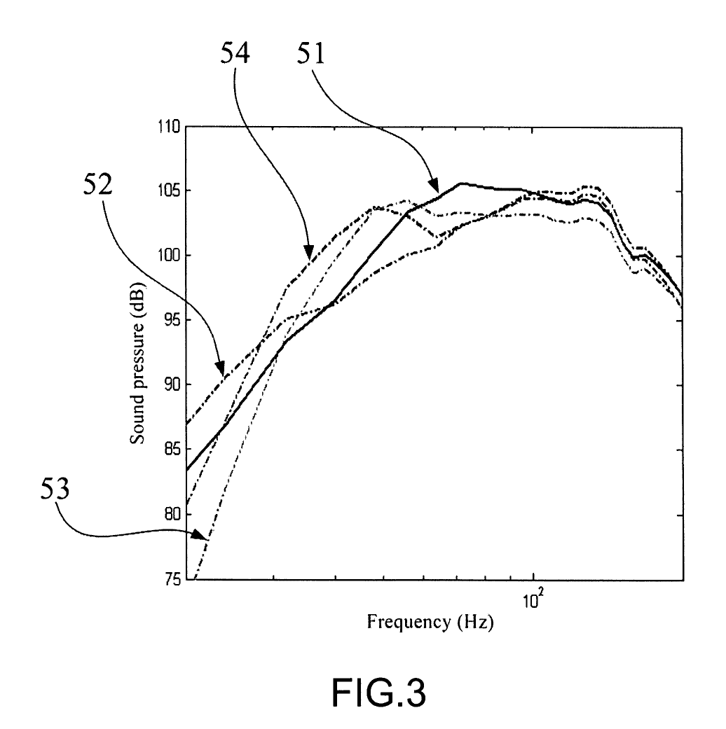

Please refer to FIG. 3, which is a view showing sound pressure curves. As shown in the figure, sound pressure curves are obtained by measuring sound pressure with a microphone positioned before a loudspeaker device for 50 centimeters, including a first sound pressure curve 51 for a general loudspeaker device, a second sound pressure curve 52 for a loudspeaker device having a feedback control device, a third sound pressure curve 53 for a loudspeaker device having a feed-forward control device, and a fourth sound pressure curve 54 for a loudspeaker device according to the present invention. Concerning the double-layer hybrid control architecture, the working frequency of the double-layer hybrid control architecture extends to the bass frequency area so that the double-layer hybrid control architecture improves the stability of the operation of the loudspeaker device at the bass frequency area, and further lowers the working frequency of the loudspeaker device.

To sum up, the present invention is a loudspeaker system having a sensorless bass compensation, where a working frequency of a loudspeaker device is lowered; adaptive loudnesses of low frequency for various spaces are obtained; and parameter drift owing to long-term operation is restrained.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A loudspeaker system having a sensorless bass compensation, comprising:
a double-layer hybrid control architecture comprising a feed-forward control device and a feedback control device; and
a volume velocity estimation observer.

2. The loudspeaker system according to claim 1,
wherein said feedback control device is deposed on an analog circuit.

3. The loudspeaker system according to claim 1,
wherein said feed-forward control device is deposed on a digital signal processor.

4. The loudspeaker system according to claim 1,
wherein said feed-forward control device further comprises at least one filtering device.

5. The loudspeaker system according to claim 1,
wherein said volume velocity estimation observer uses no sensor and obtains volume velocity according to a dynamic equation and a linear quadratic Guass theorem.

6. The loudspeaker system according to claim 1,
where in said loudspeaker system is further connected with a loudspeaker device.
